(19) United States
(12) Patent Application Publication
(10) Pub. No.: US 2012/0202110 A1
(43) Pub. Date: Aug. 9, 2012

(54) SECONDARY BATTERY CELL AND A BATTERY PACK

(75) Inventors: Yoichiro Takeuchi, Saitama-shi (JP); Shinichiro Kosugi, Saku-shi (JP)

(73) Assignee: KABUSHIKI KAISHA TOSHIBA, Tokyo (JP)

(21) Appl. No.: 13/360,921

(22) Filed: Jan. 30, 2012

Related U.S. Application Data
(60) Provisional application No. 61/448,245, filed on Mar. 2, 2011.

(30) Foreign Application Priority Data
Jan. 31, 2011 (JP) 2011-019247

(51) Int. Cl. H01M 2/08

(52) U.S. Cl. 429/185

(57) ABSTRACT

According to an embodiment, a nonaqueous electrolyte battery includes a positive electrode, a negative electrode and a nonaqueous electrolytic solution. The nonaqueous electrolytic solution includes LiBF₄ as an electrolyte and a phosphate-containing nonaqueous solvent. The negative electrode includes a lithium titanium oxide or a lithium titanium composite oxide as a negative electrode active material.

### CROSS-REFERENCE TO RELATED APPLICATIONS

This application is based upon and claims the benefit of priority from prior Japanese Patent Application No. 2011-019247, filed Jan. 31, 2011, the entire contents of which are incorporated herein by reference.

This application claims the benefit of U.S. Provisional Application No. 61/448,245, filed Mar. 2, 2011, the entire contents of which are incorporated herein by reference.

### FIELD

Embodiments described herein relate generally to a secondary battery and a battery pack.

### BACKGROUND

The embodiment relates to the structure of a secondary battery.

Lithium ion batteries with a lithium titanate as a negative electrode have been employed as long cycle-life batteries, because the reaction through the absorption and release of lithium ions is stable with almost no degradation of the active material, as compared with conventional carbon negative electrodes.

In the case of lithium ion batteries using a carbon-based active material for a negative electrode, a non-aqueous electrolytic solution with a high dielectric constant organic material such as a carbonate esters and a lithium fluoride electrolyte such as LiBF₄ and LiPF₆ are used in order to avoid the operation at an electric potential of 4 V or more, which is greater than the decomposition voltage of H₂O, and the reaction of lithium ions with H₂O.

It has been found that these materials used for the non-aqueous electrolytic solution and the electrolyte significantly degrade the battery performance through a decomposition reaction of an active material, which is produced when moisture is mixed into the non-aqueous electrolytic solution. In addition, these materials used for the non-aqueous electrolytic solution and the electrolyte often have insufficient thermal stability, and when the materials thermally decompose or react with each other, there is a possibility that H⁺ ions and OH⁻ ions will be produced to cause a further cascade of reaction. Lithium ion batteries using a conventional carbon negative electrode have been commercialized by controlling the moisture incorporation to prevent these decomposition reactions from having any harmful effects on practical uses, and specifying the stable operating temperature range to impose the range as a restriction on the use of the batteries.

Li ion rocking-chair type secondary batteries using a lithium titanate (LTO) for a negative electrode active material serve as power sources which operate at 2.5 V, typically, in such a way that a positive electrode has an electric potential on the order of 4 V to lithium metal, whereas a negative electrode has an electric potential on the order of 1.5 V to lithium metal. As compared with conventional carbon negative electrodes, there are almost no restrictions on usable electrolytic solutions and electrolytes, and thus, the combination of an electrolytic solution and an electrolyte, which can achieve a balance between high performance and safety, for example, a mixture of γ-butyrolactone (GBL) and LiBF₄, is easily selected, and the combination can constitute safer and higher-performance batteries.

However, the action of dissolving the electrode active material due to moisture incorporation is caused in the same way on one level or another. Thus, in order to achieve batteries which operate stably, there has been a need to strictly control the manufacturing environment for the prevention of impurity incorporation as in conventional cases.

### BRIEF DESCRIPTION OF THE DRAWINGS

FIG. 1 is a sectional view of a nonaqueous electrolyte battery according to a first embodiment;

FIG. 2 is an enlarged sectional view showing A part of the nonaqueous electrolyte battery in FIG. 1;

FIG. 3 is an exploded perspective view showing a battery pack according to a second embodiment; and

FIG. 4 is a block diagram showing an electric circuit of the battery pack of FIG. 3.

### DETAILED DESCRIPTION

In general, according to one embodiment, a nonaqueous electrolyte battery including a positive electrode, a negative electrode, a separator, a nonaqueous electrolytic solution and a case. The non-aqueous electrolytic solution includes LiBF₄ as an electrolyte, and a phosphate as a solvent. The negative electrode includes, as a negative electrode active material, a lithium titanium oxide or a lithium titanium composite oxide which is able to absorb lithium ions. The positive electrode includes, as a positive electrode active material, a metal oxide which has a higher electric potential (vs. lithium metal potential) than an electric potential (vs. lithium metal potential) of the negative electrode active material. The metal oxide is able to absorb lithium ions. The separator is an insulator provided between the negative electrode and the positive electrode. Lithium ions are capable of transmitting through the insulator. The separator is impregnated with the non-aqueous electrolytic solution. The non-aqueous electrolytic solution, the positive electrode, the negative electrode, and the separator are contained in the case airtightly.

According to one embodiment, a nonaqueous electrolyte battery including a positive electrode, a negative electrode and a nonaqueous electrolytic solution. The nonaqueous electrolytic solution includes LiBF₄ as an electrolyte and a phosphate-containing nonaqueous solvent. The negative electrode includes a lithium titanium oxide or a lithium titanium composite oxide as a negative electrode active material.

The embodiments will be described below.

### First Embodiment

A secondary battery cell according to the embodiment comprises: a non-aqueous electrolytic solution comprising LiBF₄ as an electrolyte, and a phosphate as a solvent; a negative electrode comprising, as a negative electrode active material, a lithium titanium oxide or a lithium titanium composite oxide, and being impregnated with the non-aqueous electrolytic solution; a positive electrode comprising, as a positive electrode active material, a metal oxide which has a higher electric potential (vs. lithium metal potential) than an electric potential (vs. lithium metal potential) of the negative electrode active material, and being impregnated with the non-aqueous electrolytic solution; and a case which holds therein the non-aqueous electrolytic solution, the positive electrode, and the negative electrode, in a liquid-tight way.

In the embodiment, the following principles are used in order to achieve a high-performance, long-life, and high-safety battery.

[Principle 1: Removal of Hydroxyl Ions from Lithium Hydroxide]

Water is ionized in a non-aqueous electrolytic solution. In an electrolytic solution which allows lithium ions to move freely, it is extremely difficult to capture and treat only hydrogen ions which are equivalent in electrical properties to lithium ions and much smaller in ionic radius than the lithium ions.

On the other hand, hydrogen ions are eventually replaced by hydroxyl ions at a negative electrode by reaction with a collapsing active material. Except for special cases such as over discharge, lithium ions are abundant in a negative electrode active material, and hydroxyl ions are thus rapidly bound to the lithium ions, and accumulated as lithium hydroxide on the surface of the negative electrode.

Accordingly, considering that the lithium hydroxide is treated through a reaction with the non-aqueous electrolytic solution, the removal of moisture from the reaction system is made possible as a result.

### [Principle 2: Utilization of Ester Decomposition Reaction]

In general, when an ester produced by dehydration and condensation between an acid and an alcohol comes into contact with a strong alkaline salt, a hydrolysis reaction occurs to produce an alcohol and a neutral salt. The utilization of this reaction makes it possible to produce no reaction normally, cause the hydroxyl ion of the lithium hydroxide to react effectively to remove the hydroxyl ion, and also rapidly treat a newly produced lithium hydroxide.

The alcohol component produced in a complementary style in this reaction preferably has a sufficiently low amount. When the alcohol component has a sufficiently low amount, the alcohol component does not react again with the other battery constituents, for example, aluminum and lithium titanate, and has stability at a vapor pressure causing no battery swell.

The produced lithium salt causes no problem as long as the salt is stable and inactive, and not decomposed again to produce oxygen, hydrogen, and other gases. In addition, when a layer is formed to be attached to the electrode surface, a material is desirable which does not break the electric conductivity between the electrolytic solution and the active material, or not interfere with the conductivity of lithium ions.

### [Principle 3: Addition of Phosphate to Non-Aqueous Electrolytic Solution]

Examples of an additive to an electrolytic solution which effectively produces the reaction in [Principle 2] for the purpose of [Principle 1] can include phosphates.

In a reaction between a phosphate and lithium hydroxide, lithium phosphate is produced. The lithium phosphate is stable and excellent in electrical insulation and lithium conductivity, which will not degrade the battery performance even when the lithium phosphate is deposited on an electrode.

The produced alcohol is desirably as heavy as possible, inactive, and low in vapor pressure.

Examples of this type of material can include trioctyl phosphate (TOP:C₂₄H₅₁O₄P:diethyl hexanol).

### [Principle 4: Production of Protective Film]

The appropriate control of the amount of mixed moisture (hydrogen ions or hydroxyl ions and the combined use with an approach such as high-temperature overheating storage (aging) can intentionally produce a lithium salt, lithium phosphate in the case of using a phosphate, on an electrode through the reaction in [Principle 3] to coat the entire electrode, thereby producing a film for protecting an active material and a current collector.

This film not only removes hydrogen ions or hydroxyl ions, but also blocks a direct electric conduction path from an electrode to an electrolytic solution without damaging the lithium mobility or electrical conduction performance, and prevents electrolysis and self-discharge of the electrolytic solution to make it possible to improve the battery performance and battery life dramatically as compared with conventional cases.

### Composition Example 1

The secondary battery cell according to the present embodiment is a secondary battery including a non-aqueous electrolytic solution including LiBF₄ as an electrolyte and a phosphate as a solvent, a negative electrode including an LTO as a negative electrode active material, and a positive electrode including a positive electrode active material which has a higher electric potential (vs. lithium metal potential) than an electric potential (vs. lithium metal potential) of the negative electrode active material.

The battery cell which has the composition as in this example has the following function effects.

The TOP itself is nonflammable. If the case is broken to cause the liquid to leak therefrom, the TOP will not catch fire, or not explode, which is a highly safe material. As the phosphate, easily available triethyl phosphate (TEP) which is considered to be less toxic to the human body can also be used in addition to the TOP. The TEP is also known as a flame-retardant material.

The TOP reacts with OH⁻ to produce an alcohol C₈H₁₇OH and PO₄⁻. The OH⁻ is produced by ionization of moisture mixed into the case as contamination in the production of the battery cell. The PO₄⁻ reacts with excess Li supplied in plenty to the positive electrode active material in the production, to produce Li₃PO₄, which is suspended as colloid in the electrolytic solution, and deposited as a stable film on the surfaces of the positive and negative electrode active materials. On the other hand, the H⁺ undergoes a redox reaction with an LTO to be converted to OH⁻ while charging, and thus, this OH⁻ will be also eventually stabilized as an alcohol and a lithium salt.

Therefore, in the secondary battery cell according to the present embodiment, as a result of the reaction of OH⁻ with the TOP, a stable material is purified to suppress the chemical reaction in the entire system, and thus prevent the electrode active material from being dissolved continuously for the degradation of the electrode. Thus, even when a reactive impurity is contained, it is less likely that the secondary battery cell will lose the function as a battery cell. Accordingly, the present embodiment makes it possible to provide a secondary battery cell which is easily controlled in quality and high in yield.

The LTO fails to reach the Li deposition potential even at low temperatures, and produces no dendrite to provide a property of causing no short circuit with the positive electrode active material. In addition, the TOP has a melting point of −90° C., which allows ion movements at low temperatures. Thus, the secondary battery cell according to the present embodiment makes it possible to provide a secondary battery cell which is safe even in the use under extremely low temperature environments.

Lithium tetrafluoroborate (LiBF₄) is used for the electrolyte which has a high degree of ionization and favorable solubility in the solvent. LiBF₄ is known as an electrolyte which produces no HF in the reaction system, and make a contribution to securing the stability of the system while ensuring output characteristics.

### Composition Example 2

A secondary battery cell is provided which uses a non-aqueous electrolytic solution with LiBF₄ as an electrolyte and a mixed solution of γ-butyrolactone and a phosphate as a solvent, in place of the non-aqueous electrolytic solution described in Composition Example 1.

The γ-butyrolactone (GBL: C₄H₆O₂) has a high ion conductivity, and improves the mobility for Li ions. Thus, the value of an electric current which is able to be input/output can be expected to be improved more than in the case of an electrolytic solution including only a phosphate.

While the mixture ratio between GBL and TOP can be set appropriately, the non-aqueous electrolytic solution including only GBL is excluded from the scope of the present example.

The GEL has properties of a melting point: −42° C. and an ignition temperature of 455° C. On the other hand, the TOP is nonflammable. In the setting for placing an emphasis on the nonflammable property, the compositional ratio of the TOP in the non-aqueous electrolytic solution constituting the secondary battery cell in actual use is desirably 20% or more and 100% or less.

In a situation that the secondary battery cell is less likely to be subjected to a destructive action, there may be no need to be concerned about the ignitible property of the non-aqueous electrolytic solution. In that case, in order to improve the mobility for Li ions, the compositional ratio of the TOP in the non-aqueous electrolytic solution constituting the secondary battery cell in actual use is allowed to be 20% or less.

### Composition Example 3

A secondary battery cell is provided which uses ethylene carbonate, diethyl carbonate, or propylene carbonate, or a mixed solution thereof, or a mixed solution thereof with GEL, in place of the GBL in Composition Example 2.

While the GBL is an excellent material in terms of ion conductivity, and thus used preferably, the time for impregnating a separator is long when the concentration is increased, because of the high viscosity of the GEL, and the number of productions per unit time may be difficult to increase in some cases. While the TOP is a material which has a record of uses a surfactant, and has a favorable impregnating property, ethylene carbonate (EC:C₃H₄O₃, diethyl carbonate (DEC:C₅H₁₀O₃), propylene carbonate (PC:C₄H₆O₃), or a mixed solution thereof can be applied as an alternative material to the GEL when it is desirable to try to further reduce the viscosity. It is also possible to adjust the overall viscosity by making a mixed solution of the carbonates with the GEL.

While the addition of EC makes a small contribution to a reduction in viscosity as compared with PC and DEC, the addition has the effect of improving the output characteristics of the secondary battery cell under high-temperature environment.

However, the EC, PC, DEC, etc. are materials which are likely to be decomposed as compared with the GEL, and may produce gas, causing the expansion of the cell. Thus, the solvent is desirably prepared so as to have a blend ratio depending on the environment of use of the secondary battery cell.

### [Other Constituents]

The non-aqueous electrolyte secondary battery cell according to the present embodiment can be applied to various forms of non-aqueous electrolyte secondary battery cells, such as square, cylindrical, flattened, thin, and coin-type non-aqueous electrolyte secondary battery cells.

The constituents other than those above will be described below.

### 1) Negative Electrode

The negative electrode includes: a negative electrode current collector; and a negative electrode layer containing a negative electrode active material, a conducting agent, and a binder, which is supported on one or both surfaces of the negative electrode current collector.

The negative electrode current collector is aluminum foil or aluminum alloy foil, which has an average crystal grain size of 50 μm or less.

The average crystal grain size in the range of 50 μm or less can increase the strength of the aluminum foil or aluminum alloy foil dramatically, as described in the example. This increased strength of the negative electrode current collector improves the physical and chemical stability, thereby making the negative electrode current collector less likely to undergo disconnection. In particular, the degradation of the negative electrode current collector due to dissolution can be prevented, which is significant in an over-discharge long-term cycle under high-temperature environment at 40° C. or more, and the increase in electrode resistance can be thus suppressed.

Furthermore, the suppression of the increase in electrode resistance decreases the Joule heat, thereby making it possible to suppress the heat produced by the electrode.

In addition, the increased strength of the negative electrode current collector allows the negative electrode to have a higher density without causing the negative electrode current collector to undergo disconnection, thereby improving the capacity density. In addition, the higher density of the negative electrode increases the thermal conductivity, thereby making it possible to improve the radiation performance of the electrode.

Furthermore, the synergistic effect between the suppression of the heat produced by the battery cell and the improvement in the radiation performance of the electrode allows the suppression of an increase in battery temperature.

It is to be noted that the average crystal grain size is more preferably 3 μm or less. As will be mentioned in the example, this average crystal grain size further enhances the effect described above. While the chemical and physical strengths of the negative electrode current collector are increased as the average crystal grain size is smaller, the microstructure is desirably crystalline in order to achieve good conductivity. Thus, the lower limit of the average crystal grain size is desirably 0.01 μm.

The aluminum foil or aluminum alloy foil with an average crystal grain size in the range of 50 μm or less is affected in a composite manner by factors such as material compositions, processing conditions, heating conditions, and cooling conditions, and the average crystal grain size is adjusted by organically combining the factors in the production process. It is to be noted that high-performance aluminum foil PACAL 21 (trade name) from Nippon Foil Mfg. Co., Ltd., may be used as the aluminum foil for the negative electrode current collector.

Specifically, the aluminum foil with an average crystal grain size of 50 μm or less can be prepared by subjecting aluminum foil with an average crystal grain size of 90 μm to an anneal treatment at 50 to 250° C., and then cooling the aluminum foil to room temperature. On the other hand, the aluminum alloy foil with an average crystal grain size of 50 μm or less can be prepared by subjecting aluminum alloy foil with an average crystal grain size of 90 μm to an anneal treatment at 50 to 250° C., and then cooling the aluminum alloy foil to room temperature. Alternatively, the aluminum alloy foil with an average crystal grain size of 50 μm or less can also be prepared by subjecting an alloy containing 0.8 to 2 weight % of Fe to an anneal treatment.

The average crystal grain sizes of the aluminum and aluminum alloy are measured by the method described below. The surface texture of the negative electrode current collector is observed under a metallograph to measure the number n of crystal grains present in a field of 1 mm×1 mm, and the average crystal grain area S (μm²) is calculated from the following formula (0).

S=(1×10⁶)/n (0)

where the value represented by (1×10⁶) refers to the field area of 1 mm×1 mm (μm²), and n is the number of crystal grains.

With the use of the obtained average crystal grain area S, the average crystal grain size d (μm) is calculated from the following formula (1). This calculation of the average crystal grain size d is carried out for 5 locations (5 fields), and the average value is regarded as an average crystal grain size. It is to be noted that the estimated error is approximately 5%.

d=2(S/π)^{1/2} (1)

The thickness of the negative electrode current collector is preferably 20 μm or less for increasing the capacity. A more preferable range is 12 μm or less. In addition, the thickness of the negative electrode current collector desirably has a lower limit of 3 μm.

The purity of the aluminum used for the negative electrode current collector is preferably 99.99% or more for improving the corrosion resistance and increasing the strength. As the aluminum alloy, alloys are preferable which contain one or more elements selected from the group cons log of iron, magnesium, zinc, manganese, and silicon in addition to aluminum. For example, Al—Fe alloys, Al—Mn based alloys, and Al—Mg based alloys are able to achieve higher strengths than that of aluminum. On the other hand, the content of the transition metals such as nickel and chromium in the aluminum and aluminum alloy is preferably adjusted to 100 ppm or less (including 0 ppm). For example, Al—Cu based alloys increase the strength, but deteriorate the corrosion resistance, which are thus not suitable as current collectors.

The content of aluminum in the aluminum alloy is desirably adjusted to 95 weight % or more and 99.5 weight % or less. This is because there is a possibility that a sufficient strength will not be achieved outside the range even when the average crystal grain size is adjusted to 50 μm or less. A more preferable aluminum content is 98 weight % or more and 99.5 weight % or less.

Primary particles for the negative electrode active material desirably have an average particle size of 1 μm or less.

This range can improve the cycle performance as will be described later in the example. In particular, this effect is pronounced during discharge with high output. This is because, for example, in the case of a negative electrode active material which absorbs and releases lithium ions, as the particle size is smaller, the diffusion distance for lithium ions in the active material is shortened to increase the specific surface area.

Further, a more preferable average particle size is 0.3 μm or less. As described in the example, this average particle size further enhances the effect described above. However, when the average particle size is smaller, there is a possibility that primary particle aggregation may be likely to be caused, or the distribution of the non-aqueous electrolyte may be biased toward the negative electrode to cause depletion of the electrolyte in the positive electrode. Thus, the lower limit is desirably adjusted to 0.001 μm.

In general, in a press step for an electrode, the load on the current collector is increased as the average particle size of the active material is smaller. This negative electrode active material has an average particle size of 1 μm or less, and thus applies a large load onto the negative electrode current collector. Therefore, conventional negative electrode current collectors are likely to cause disconnection. However, the negative electrode current collector for use in the embodiment has a high strength, and thus can withstand even a large load caused by particles with an average particle size of 1 μm or less.

The negative electrode active material having primary particles with an average particle size of 1 μm or less is obtained by causing raw materials for the active material to undergo a reactive synthesis to prepare an active material precursor, then carrying out a baking, and applying a grinding treatment with the use of a grinding mill such as a ball mill or a jet mill. It is to be noted that in the baking, the active material precursor may partially aggregate and grow to secondary particles which are larger in particle size. For this reason, the negative electrode active material is allowed to include secondary particles. The active material precursor is preferably a powder of 1 μm or less, because the grinding treatment is simpler for a material which is smaller in particle size.

Materials which absorb and release lithium can be used as the negative electrode active material, and above all, examples of the materials include metal oxides, metal sulfides, metal nitrides, and alloys. The metal oxides include, for example, tungsten oxides such as, for example, WO₃, amorphous tin oxides such as, for example, SnB_{0.4}P_{0.6}O_{3.1}, tin silicon oxides such as, for example, SnSiO₃, silicon oxides such as, for example, SiO, and lithium titanates of spinel structure such as, for example, Li₄₊ₓTi₅O₁₂.

Most preferable materials among the metal oxides are lithium titanium oxides (lithium-titanium composite oxides) such as lithium titanates. On the other hand, preferable metal sulfides include, for example, lithium sulfides such as, for example, TiS₂, molybdenum sulfides such as, for example, MoS₂, and iron sulfides such as, for example, FeS, FeS₂, and LiₓFeS₂. In addition, preferable metal nitrides include, for example, lithium cobalt nitrides such as LiₓCo_{y}N (0<x<4, 0<y<0.5). In particular, lithium titanates are preferable in terms of cycle performance. This is because the lithium titanate has a lithium absorbing potential of approximately 1.5 V, which is an electrochemically stable material with respect to the aluminum foil current collector or the aluminum alloy foil current collector.

Here, lithium titanium composite oxide refers to a lithium titanium oxide in which a part of constituent elements thereof are substituted by different elements.

The lithium absorbing potential of the negative active material is preferably 0.4 V or more as the open circuit potential with respect to the open circuit potential of lithium metal. This lithium absorbing potential can inhibit the progress of an alloying reaction between the aluminum component of the negative electrode current collector and lithium, and the particle size reduction of the negative electrode current collector. Furthermore, the lithium absorbing potential of the negative electrode active material preferably falls within the range of 0.4 V or more and 3 V or less as the open circuit potential with respect to the open circuit potential of lithium metal. This range can improve the battery voltage. A more preferable range of the electric potential is 0.4 V or more and 2 V or less.

Metal oxides which are able to absorb lithium in the range of 0.4 V or more and 3 V or less include titanium oxides such as, for example, TiO₂, lithium titanium oxides such as, for example, Li₄₊ₓTi₅O₁₂ (−1≦x≦3) and Li₂Ti₃O₇, tungsten oxides such as, for example, WO₃, amorphous tin oxides such as, for example, SnB_{0.4}P_{0.6}O_{3.1}, tin silicon oxides such as, for example, SnSiO₃, and silicon oxides such as, for example, SiO. Above all, the lithium titanate oxides are preferable.

Metal sulfides which are able to absorb lithium in the range of 0.4 V or more and 3 V or less include lithium sulfides such as, for example, TiS₂, molybdenum sulfides such as, for example, MoS₂, and iron sulfides such as, for example, FeS, FeS₂, and LiₓFeS₂.

Metal nitrides which are able to absorb lithium in the range of 0.4 V or more and 3 V or less include lithium cobalt nitrides such as, for example, LiₓCo_{y}N (0<x<4, 0<y<0.5).

Carbon materials can be used as the conducting agent for increasing the electron conductivity and reducing the contact resistance with the current collector. For example, the carbon materials include acetylene black, carbon black, coke, carbon fibers, and graphite.

Examples of the binder for binding the active material and the conducting agent include, for example, polytetrafluoroethylene (PTFE), pclyvinylidene fluoride (PVdF), fluorine-containing rubbers, and styrene butadiene rubbers.

The blend ratio among the active material, conducting agent, and binder of the negative electrode is preferably adjusted so as to provide the negative electrode active material in the range of 80 weight % or more and 95 weight % or less, the conducting agent in the range of 3 weight % or more and 18 weight % or less, and the binder in the range of 2 weight % or more and 7 weight % or less. The conducting agent in the range of 3 weight % or more can produce the effect described above, whereas the conducting agent in the range of 18 weight % or less can reduce the decomposition of the non-aqueous electrolyte at the surface of the conducting agent under storage at high temperatures. The binder in the range of 2 weight % or more can achieve a sufficient electrode strength, whereas the binder in the range of 7 weight % or less can reduce an insulating portion of the electrode.

The density of the negative electrode is desirably adjusted to 1.5 g/cm³ or more and 5 g/cm³ or less. This density can achieve a high battery capacity. A more preferable range is 2 g/cm³ or more and 4 g/cm³ or less.

The negative electrode is prepared by, for example, suspending the negative electrode active material, the conducting agent, and the binder in an appropriate solvent, applying this suspension onto the current collector of the aluminum foil or aluminum alloy foil, and applying drying and pressing.

### 2) Positive Electrode

The positive electrode includes: a positive electrode current collector; and a positive electrode layer containing a positive electrode active material, a conducting agent, and a binder, which is supported on one or both surfaces of the positive electrode current collector.

Examples of the positive electrode current collector can include, for example, aluminum foil and aluminum alloy foil. The aluminum foil and aluminum alloy foil each preferably have an average crystal grain size of 50 μm or less. More preferably, the average crystal grain size is 3 μm or less. This average crystal grain size increases the strength the positive electrode current collector, and allows the positive electrode to have a higher density without causing the positive electrode current collector to undergo disconnection, thereby improving the capacity density. The smaller average crystal grain size makes it possible to reduce the occurrence of pinholes and cracks, and can increase the chemical strength and physical strength of the positive electrode current collector. In order to ensure an appropriate hardness in such a way that the microstructure of the current collector is crystalline, the average crystal grain size desirably has a lower limit of 0.01 μm.

The thickness of the positive electrode current collector is preferably 20 μm or less for increasing the capacity. A more preferable range is 15 μm or less, in addition, the thickness of the positive electrode current collector desirably has a lower limit of 3 μm.

Examples of the positive electrode active material include oxides, sulfides, and polymers.

The oxides include, for example, manganese dioxide (MnO₂), iron oxides, copper oxides, nickel oxides, lithium-manganese composite oxides such as, for example, LiₓMn₂O₄ or LiₓMnO₂, lithium-nickel composite oxides such as, for example, LiₓNiO₂, lithium-cobalt composite oxides such as, for example, LiₓCoO₂, lithium-nickel-cobalt composite oxides such as, for example, LiNi_{1-y}Co_{y}O₂, lithium-manganese-cobalt composite oxides such as, for example, LiMn_{y}Co_{1-y}O₂, spinel-type lithium-manganese-nickel composite oxides such as, for example, LiₓMn_{2-y}Ni_{y}O₄, lithium-phosphorus oxides which have an olivine structure, such as, for example, LiₓFePO₄, Fe_{1-y}Mn_{y}PO₄, and LiₓCoPO₄, iron phosphates such as, for example, Fe₂(SO₄)₃, and vanadium oxides such as, for example, V₂O₅. It is to be noted that x and y are preferably in the range of 0 to 1.

For example, the polymers include conductive polymer materials such as polyaniline and polypyrrole, and disulfide-based polymer materials. In addition, sulfur (S), carbon fluoride, and the like can be used.

Preferable positive electrode active materials include, for the achievement of higher positive electrode voltages, lithium-manganese composite oxides such as LiₓMn₂O₄, lithium-nickel composite oxides, lithium-cobalt composite oxides, lithium-nickel-cobalt composite oxides, spinel-type lithium-manganese-nickel composite oxides, lithium-manganese-cobalt composite oxides, and lithium iron phosphate such as LiₓFePO₄.

Examples of the conducting agent for increasing the electron conductivity and reducing the contact resistance with the current collector include, for example, acetylene black, carbon black, and graphite.

Examples of the binder for binding the active material and the conducting agent include, for example, polytetrafluoroethylene (PTFE), polyvinylidene fluoride (PVdF), and fluorine-containing rubbers.

The blend ratio among the positive electrode active material, conducting agent, and binder is preferably adjusted so as to provide the positive electrode active material in the range of 80 weight % or more and 95 weight % or less, the conducting agent in the range of 3 weight % or more and 18 weight % or less, and the binder in the range of 2 weight % or more and 7 weight % or less. The conducting agent in the range of 3 weight % or more can produce the effect described above, whereas the conducting agent in the range of 18 weight % or less can reduce the decomposition of the non-aqueous electrolyte at the surface of the conducting agent under storage at high temperatures. The binder in the range of 2 weight. % or more can achieve a sufficient electrode strength, whereas the binder in the range of 7 weight % or less can reduce an insulating portion of the electrode.

The positive electrode is prepared by, for example, suspending the positive electrode active material, the conducting agent, and the binder in an appropriate solvent, applying this suspension onto the positive electrode current collector, and applying drying and pressing.

### 3) Non-Aqueous Electrolyte

Examples of the non-aqueous electrolyte include a liquid non-aqueous electrolyte prepared by dissolving an electrolyte in an organic solvent, a gel-like non-aqueous electrolyte obtained by the combination of a liquid electrolyte and a polymer material, or a solid non-aqueous electrolyte obtained by the combination of a lithium salt electrolyte and a polymer material. In addition, ionic liquid containing lithium ions may be used as the non-aqueous electrolyte.

The liquid non-aqueous electrolyte is prepared by dissolving, in an organic solvent, an electrolyte in a concentration of 0.5 to 2 mol/L.

Examples of the electrolyte include LiBF₄. For the type of the electrolyte used, two or more can be mixed from such lithium salts that have no influences on the reaction system.

The organic solvent has been described in the composition examples mentioned above, and can be used in the form of a single solvent or a mixture of two or more solvents.

Examples of the polymer material can include, for example, polyvinylidene fluoride (PVdF), polyacrylonitrile (PAN), and polyethylene oxide (PEO).

In addition, the ionic liquid preferably includes a lithium ion, an organic cation, and an organic anion. Furthermore, the ionic liquid is desirably liquid, at 100° C. or less, preferably at room temperature or less.

The non-aqueous electrolyte secondary battery cell according to one embodiment can further include a separator provided between the positive electrode and the negative electrode, and a case for housing the separator and the electrode.

### 4) Separator

For example, nonwoven fabrics of synthetic resin, polyethylene porous films, polypropylene porous films, etc. can be used as the separator.

### 5) Case

Examples of the case include cases of laminate film with a thickness of 0.2 mm or less, and metallic cases with a thickness of 0.5 mm or less. The shape of the case is changed depending on the form of the non-aqueous electrolyte secondary battery. Examples of the form of the non-aqueous electrolyte secondary battery include flattened, square, cylindrical, coin-type, button-type, sheet-shaped, and laminate-type non-aqueous electrolyte secondary battery cells, and large-size battery cells mounted on electric cars, etc.

The thickness of the laminate film preferably has a range of 0.5 mm or less. In addition, the thickness of the laminate film desirably has a lower limit of 0.01 mm.

On the other hand, the thickness of the metallic case preferably has a range of 0.5 mm or less. In addition, the thickness of the metallic case desirably has a lower limit of 0.05 mm.

Examples of the laminate film can include, for example, a multilayer film including a metal layer and a resin layer for coating the metal layer. For the reduction in weight, the metal layer is preferably aluminum foil or aluminum alloy foil. The resin layer is intended to reinforce the metal layer, and can be formed from polymers such as polypropylene (PP), polyethylene (PE), nylon, polyethylene terephthalate (PET).

The case of laminate film is obtained by, for example, sealing the laminate film through thermal fusion bonding.

The metallic case is desirably formed from aluminum or an aluminum alloy. The aluminum and aluminum alloy each preferably have an average crystal grain size of 50 μm or less. The average crystal grain size adjusted to 50 μm or less increases the strength of the metallic case of the aluminum or aluminum alloy, which can ensure a sufficient mechanical strength even when the case is reduced in thickness. This mechanical strength ensured with the thickness reduced can improve the radiation performance of the case, and thus suppress the increase in battery temperature. In addition, the improvement in energy density also allows the reduction in the weight and size of the battery cell. Further, the average crystal grain size is more preferably 10 μm or less. Is will be mentioned in the example, this average crystal grain size further enhances the effect described above. While the chemical and physical strengths of the case are increased as the average crystal grain size is smaller, the microstructure is desirably crystalline in order to achieve good conductivity. Thus, the lower limit of the average crystal grain size is desirably 0.01 μm.

These features are preferred for battery cells requiring high-temperature conditions, high energy densities, etc., for example, secondary battery cells for automobile use.

For the same reason as in the case of the negative electrode current collector, the purity of aluminum is preferably 99.99% or more. An alloy containing an element such as magnesium, zinc, and silicon are preferable as the aluminum alloy.

On the other hand, in each of the aluminum and the aluminum alloy, the content of transition metals such as iron, copper, nickel, and chromium is preferably 100 ppm or less.

The metallic case can be sealed with the use of laser. For this reason, as compared with the laminate film case, the volume for sealing can be reduced, and the energy density can be improved.

Next, referring to drawings, a nonaqueous electrolyte battery according to the first embodiment will be explained in more detail.

It should be noted that each drawing is a schematic view for facilitating the explanation of an embodiment and the understanding thereof. There are some cases, therefore, in which the shape, size and ratio are different from those of an actual device, and the design changes of such differences can be suitably made considering explanations described below and known techniques.

A flat, wound electrode group 9 is housed in a sac-like case 10 which is formed from a laminated film in which a metal layer lies between two resin layers. The flat, wound electrode group 9 is formed, as shown in FIG. 2, in procedures in which a negative electrode 11, a separator 12, a positive electrode 13 and a separator 12 are laminated in this order from the outside to form a laminate, then the laminate is spirally wound, and the resulting product is subjected to press-molding.

The negative electrode 11 includes a negative electrode current-collector 11a and a negative electrode material layer 11b. The negative electrode material layer 11b includes a negative electrode active material and an electron conductive substance. The negative electrode 11 of the outermost layer has, as shown in FIG. 2, a structure in which the negative electrode material layer 11b is formed on one interior side of the negative electrode current-collector 11a. Other negative electrodes 11 have negative electrode material layers 11b formed on both sides of the negative electrode current-collector 11a.

In the positive electrode 13, positive electrode material layers 13b are formed on both side of a positive electrode current-collector 13a.

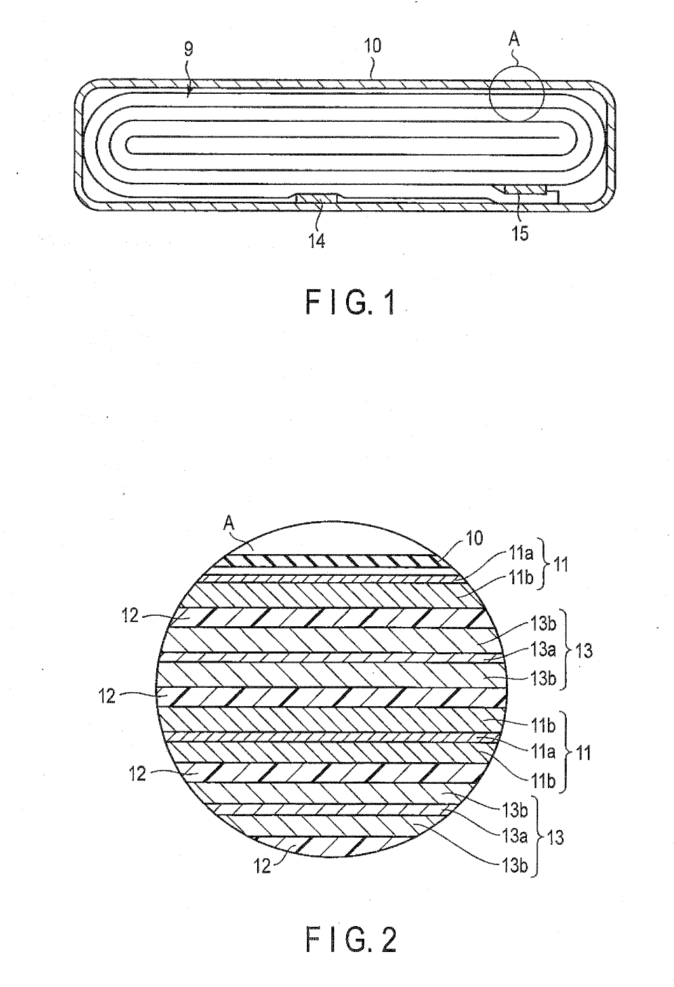

As shown in FIG. 1, a negative electrode terminal 14 is connected to the negative electrode current-collector 11a in the outermost layer of the negative electrode 11, and a positive electrode terminal 15 is connected to the positive electrode current-collector 13a in the inner positive electrode 13, in the vicinity of the outer peripheral edge of the wound electrode group 9. These negative electrode terminal 14 and positive electrode terminal 15 extend outward from an opening of the sac-like case 10. For example, liquid nonaqueous electrolyte is injected from the opening of the sac-like case 10. The negative electrode terminal 14 and the positive electrode terminal 15 are put in the opening of the sac-like case 10, which is heat-sealed, thereby completely sealing the wound electrode group 9 and the liquid nonaqueous electrolyte.

The negative electrode terminal is formed from, for example, a material which is electrochemically stable at a Li absorbing and releasing potential of the negative electrode active material and has conductivity. Specifically it is formed from copper, nickel, stainless steal or aluminum, or aluminum alloy including an element such as Mg, Ti, Zn, Mn, Fe, Cu or Si. In order to reduce contact resistance with the negative electrode current-collector, the negative electrode terminal is preferably formed from the same material as that used for the negative electrode current-collector.

The positive electrode terminal is formed from, for example, a material which has electrical stability in a range of a potential against lithium metal of 3 V or higher and 5 V or lower, preferably 3.0 or higher and 4.25 V or lower, and conductivity. Specifically, it is formed from aluminum or aluminum alloy including an element of Mg, Ti, Zn, Ni, Cr, Mn, Fe, Cu, Si or the like. In order to reduce contact resistance with the positive electrode current-collector, the positive electrode terminal is preferably formed from the same material as that used for the positive electrode current-collector.

According to the first embodiment, a nonaqueous electrolyte secondary battery having a high output performance, a long charge-discharge cycle life, and a high safety can be provided, because the battery includes the nonaqueous electrolytic solution including LiBF₄ as the electrolyte and the phosphate-containing nonaqueous solvent, and the negative electrode including the lithium titanium oxide or the lithium titanium composite oxide as the negative electrode active material.

### Second Embodiment

A battery pack according to a second embodiment has one or more nonaqueous electrolyte batteries (unit cells) of the first embodiment. When the pack has multiple unit cells, each unit cell is connected electrically in series or in parallel.

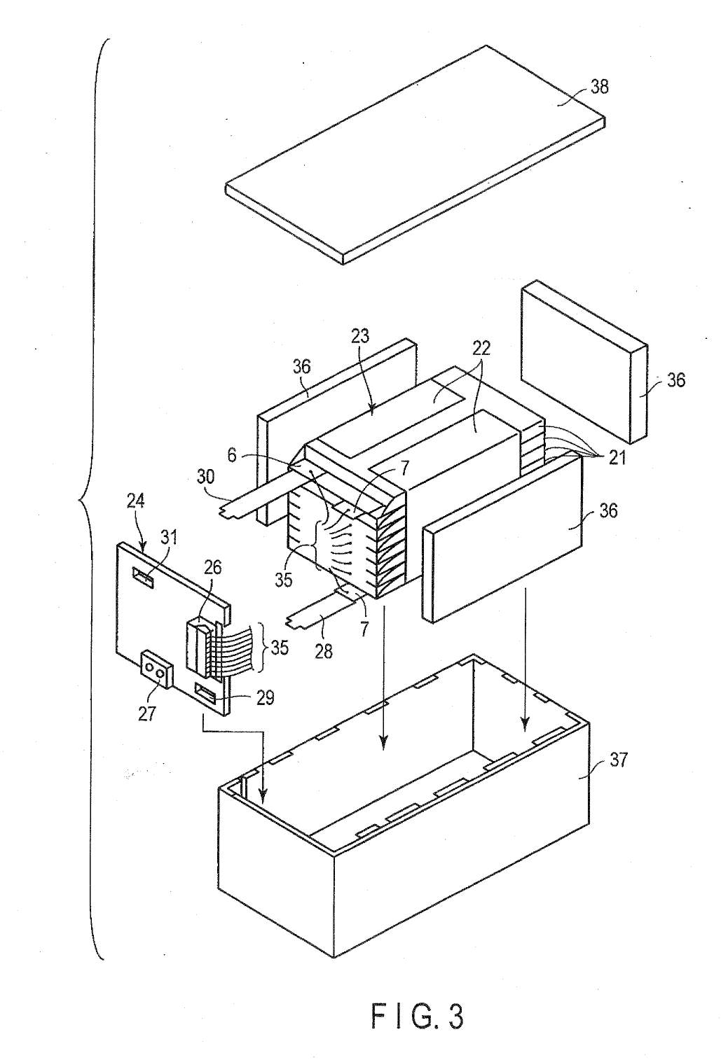

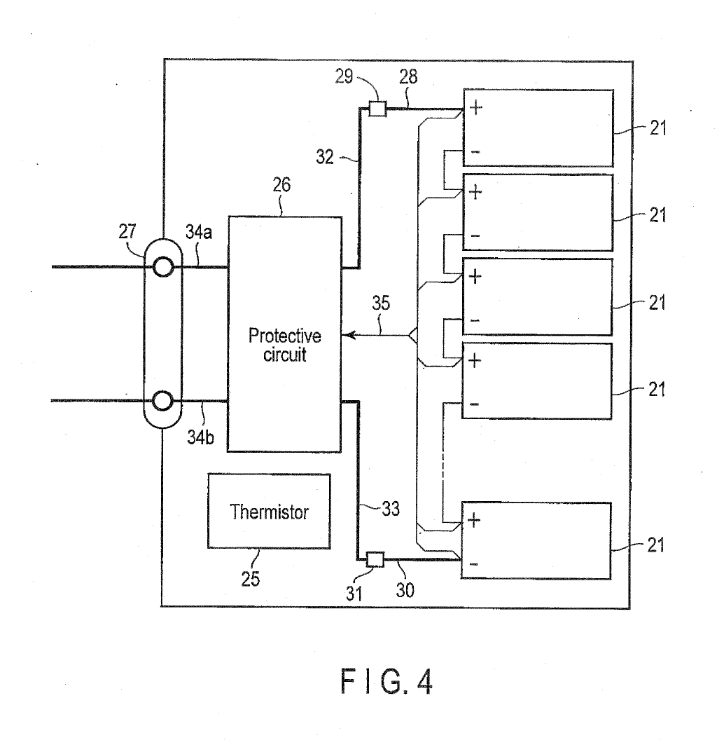

Referring to FIG. 3 and FIG. 4, such a battery pack will be explained in detail. As the unit cell, for example, a flat-type battery can be used.

Multiple unit cells 21, configured from flat-type nonaqueous electrolyte batteries, are laminated so that a negative electrode terminal 6 and a positive electrode terminal 7, which extend outward, are arranged in the same direction, and they are fastened with an adhesive tape 22 to configure a battery module 23. These unit cells 21 are electrically connected in series to each other, as shown in FIG. 4.

A printed wiring board 24 is located so that it faces side faces of the unit cell 21 from which the negative electrode terminal 6 and the positive electrode terminal 7 extend. As shown in FIG. 4, thermister 25, a protective circuit 26 and a terminal 27 for current supply to the external equipment are mounted on the printed wiring board 24. It should be noted that an insulating plate (not shown) is attached to a surface of the protective circuit board 24 facing the battery module 23, in order to avoid unnecessary contact with wirings of the battery module 23.

A lead 28 at the positive electrode side is connected to the positive electrode terminal 7 positioned in the undermost layer of the battery module 23, and its tip is inserted into a connector 29 at the positive electrode side of the printed wiring board 24 to electrically connect it. A lead 30 at the negative electrode side is connected to the negative electrode terminal 6 positioned in the uppermost layer of the battery module 23, and its tip is inserted into a connector 31 at the negative electrode side of the printed wiring board 24 to electrically connect it. These connectors 29 and 31 are connected to a protective circuit 26 through wirings 32 and 33 formed on the printed wiring board 24.

The thermister 25 detects a temperature of the unit cell 21, and the detection signal thereof is sent to a protective circuit 26. The protective circuit 26 can interrupt a wiring 34a at a plus side and a wiring 34b at a minus side between the protective circuit and the terminal 27 at a pre-determined condition. The pre-determined condition may include, for example, a condition in which the detection temperature of the thermister 25 is over a pre-determined temperature. Also, the pre-determined condition may include a condition in which over charge, over-discharge and over-current of the unit cell 21 are detected. Each of the unit cells 21 or the unit cells 21 as a whole is subjected to the detection of the over charge and the like. When each of the unit cells 21 is detected, a battery voltage may be detected, or a positive electrode potential or a negative electrode potential may be detected. In the later case, a lithium electrode is inserted into each unit cell 21 as a reference electrode. In the cases of FIG. 3 and FIG. 4, a wiring 35 is connected to each unit cell for voltage detection, and detection signals are sent to the protective circuit 26 through these wirings 35.

A rubber or resin protective sheet 36 is located on each of three side faces of the battery module 23 except for the side face from which the positive electrode terminal 7 and the negative electrode terminal 6 protrude.

The battery module 23 is housed in a housing case 37 together with each of the protective sheets 36 and the printed wiring board 24. In other words, protective sheets 36 are located on both of inner surfaces in a long side direction of the housing case 37 and one inner surface in a short side direction of the housing case 37, and the printed wiring board 24 is located on the opposite inner side in the short side direction. The battery module 23 is positioned in a space surrounded by the protective sheet 36 and the printed wiring board 24. A lid 38 is attached to a top face of the housing case 37.

For fixing the battery module 23, a thermally shrinkable tape may be used instead of the adhesive tape 22. In that case, after protective sheets are located at both of side faces of a battery module, it is surrounded by a heat shrink tube, and then the heat shrink tube is thermally shrunk to bind the battery module.

Although FIG. 3 and FIG. 4 showed the embodiment in which the unit cells 21 are connected in series, they may be connected in parallel, for increasing a battery capacity. Assembled battery packs may be connected in series or in parallel.

The embodiment of the battery pack may be appropriately altered depending on the application thereof. The application of the battery pack may include preferably applications in which cycle characteristics at high-current are desired. Specifically, the application may include applications as power sources for digital cameras, or for mounting on cars such as bicycles to four-wheeled hybrid electric cars, bicycles to four-wheeled electric cars, and power-assisted bicycles Particularly, it is preferably used for mounting on cars.

According to the battery pack of the second embodiment, battery pack having a high output performance and excellent charge-discharge cycle properties can be provided, because it includes the nonaqueous electrolyte battery of the first embodiment.

Preparation examples will be described below.

It is to be noted that modifications can be made without departing from the scope of the embodiments, and the embodiments are not limited to the following example.

### <Preparation of Negative Electrode>

A lithium titanate (Li₄Ti₅O₁₂) powder with an average particle size of 5 μm and a Li absorbing potential of 1.55 V (vs. Li/Li) as the active material, a carbon powder with an average particle size of 0.4 μm as the conducting agent, and polyvinylidene fluoride (PVdF) as the binder were blended to have a ratio by weight of 90:7:3, and dispersed in an n-methylpyrrolidone (NMP) solvent to prepare a slurry.

It is to be noted that a laser diffraction particle size analyzer (Shimadzu Corporation: Model Number SALD-300) was used for the measurement of the particle size for the active material. First, an approximately 0.1 g of sample was put in a beaker or the like, then subjected to sufficient stirring with the addition of a surfactant and 1 to 2 mL of distilled water to the sample, and injected to a stirring tank. The light intensity distribution was measured 64 times at intervals of 2 seconds to analyze the particle size distribution data, and determine the particle size (D50) of 50% in cumulative frequency distribution as the average particle size.

On the other hand, aluminum foil (purity: 99.99%) 10 μm in thickness and 50 μm in average crystal grain size was prepared as the negative electrode current collector.

The slurry was applied onto the obtained negative electrode current collector, dried, and then subjected to pressing, thereby preparing a negative electrode with an electrode density of 2.4 g/cm³.

### <Preparation of Positive Electrode>

A lithium cobalt oxide (LiCoO₂) as the active material, a graphite powder as the conducting agent, and polyvinylidene fluoride (PVdF) as the binder were blended to have a ratio by weight of 87:8:5, and dispersed in an n-methylpyrrolidone (NMP) solvent to prepare a slurry. The slurry was applied onto aluminum foil (purity: 99.99%) of 15 μm in thickness and 10 μm in average crystal grain size, dried, and then subjected to pressing, thereby preparing a positive electrode with an electrode density of 3.5 g/cm³.

An aluminum containing laminate film of 0.1 mm in thickness was prepared as a material for the formation of the case. This aluminum containing laminate film had an aluminum layer of approximately 0.03 mm in film thickness and of approximately 100 μm in average crystal grain size. Polypropylene was used for the resin for reinforcing the aluminum layer. This laminate film was sealed by thermal fusion bonding to obtain a case.

Then, a strip-shaped positive electrode terminal was electrically connected to the positive electrode, and a strip-shaped negative electrode terminal was electrically connected to the negative electrode. A separator of a polyethylene porous film of 12 μm in thickness was attached to the positive electrode to coat the positive electrode. The negative electrode was stacked on the positive electrode coated with the separator so as to be opposed to each other, and wound in a spiral configuration to prepare an electrode group. This electrode group was subjected to pressing into a flattened shape.

The electrode group formed into the flattened shape was inserted into the case.

A lithium salt, LiBF₄ was dissolved at 1.5 mol/L in an organic solvent of EC, GBL, and TOP mixed at a ratio of 1:2:7 in volume ratio (EC:GBL:TOP) to prepare a liquid non-aqueous electrolyte.

The obtained non-aqueous electrolyte was injected into the case of the laminate insulating sheet processed into a bag to create a flattened non-aqueous electrolyte secondary battery of 3.8 mm in thickness, 63 mm in width, and 95 mm in height.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-aqueous electrolyte secondary battery comprising:
a non-aqueous electrolytic solution comprising LiBF₄ as an electrolyte, and a phosphate as a solvent;
a negative electrode comprising, as a negative electrode active material, a lithium titanium oxide or a lithium titanium composite oxide which is able to absorb lithium ions;
a positive electrode comprising, as a positive electrode active material, a metal oxide which has a higher electric potential to lithium metal than an electric potential of the negative electrode active material, and is able to absorb lithium ions;
a separator which is an insulator provided between the negative electrode and the positive electrode, lithium ions capable of transmitting through the insulator, and is impregnated with the non-aqueous electrolytic solution; and
a case which airtightly holds therein the non-aqueous electrolytic solution, the positive electrode, the negative electrode, and the separator.

2. The non-aqueous electrolyte secondary battery, which uses a non-aqueous electrolytic solution comprising LiBF₄ as an electrolyte and a mixed solution of γ-butyrolactone and a phosphate as a solvent, in place of the non-aqueous electrolytic solution according to claim 1.

3. The non-aqueous electrolyte secondary battery which uses at least one of ethylene carbonate, diethyl carbonate, and propylene carbonate, in place of γ-according to claim 2.

4. A nonaqueous electrolyte secondary battery, comprising:
a nonaqueous electrolytic solution comprising LiBF₄ as an electrolyte and a phosphate-containing nonaqueous solvent;
a negative electrode comprising a lithium titanium oxide or a lithium titanium composite oxide as a negative electrode active material; and
a positive electrode.

5. A battery pack comprising the nonaqueous electrolyte secondary battery according to claim 1.
